(19) United States
(12) Patent Application Publication
(10) Pub. No.: US 2010/0108144 A1
(43) Pub. Date: May 6, 2010

(54) Flow controlled Y connector

(76) Inventors: Garry Edward Yates, Las Vegas, NV (US); Shelley Yates, Las Vegas, NV (US)

Correspondence Address: Garry Yates, 4085 Dustin Avenue, Las Vegas, NV, 89120, US

(21) Appl. No.: 12/290,992

(22) Filed: Nov. 6, 2008

(51) Int. Cl. F16K 15/00

(52) U.S. Cl. 137/1; 137/455

(57) ABSTRACT

The Flow Controlled Y Connector is a device used to control the flow of a mixture of air, water, and debris that occurs as a result of a vacuum that is created by carpet cleaning equipment. This device is effectively a piping and valve system that opens and closes based on the flow rate of the matter passing through the system.

The purpose of this patent application is to claim ownership over the Flow Controlled Y Connector. This device is used to control the flowrate of air, water and debris being vacuumed out of carpet by a carpet cleaning machine. Current Y-Connectors (FIG. 6) do not incorporate a method of controlling the suction of the carpet cleaning equipment. The device that has been proposed in this patent controls the flow of air through the system with a Flow Control Valve Assembly. The assembly uses a flap that opens and closes to control such flow.

The major components of the Flow Controlled Y-Connector include:
One Y-Connector
Two Flow Control Valve Assemblies
Two End Sections

The Y-Connector is connected to the Flow Valve Assemblies which is then connected to the End Sections. This arrangement allows for the necessary flow control.

### BACKGROUND INFORMATION

The process of cleaning carpets is a relatively straight forward endeavor. The worker has a wand that is connected to a vacuum system and a watering system (see FIG. 1). The watering system wets the carpet and the vacuum system draws the water out as well as much of the dirt and debris that has collected on the carpet.

The Flow Controlled Y Connector is a device that can allow two wands to be connected to the machine. Currently there are Y Connectors however there is no valve system to control the flow rate of the air and debris being removed from the carpet (see FIG. 2). The current Y-connectors perform well when both wands are effectively on top of the carpet (FIG. 3), however if one worker is to lift his wand off of the carpet there is a significant drop in vacuum pressure (see FIG. 4). This drop in pressure decreases the effectiveness of the whole carpet cleaning system. Without proper suction the carpet cleaning equipment becomes unproductive.

### BRIEF SUMMARY OF THE INVENTION

Currently used Y-Connectors when used with carpet cleaning equipment do not address issues caused due to the removal of one wand from the surface of the carpet that is being cleaned. The Flow-Controlled Y-Connector that has been proposed in this patent addresses this issue through the introduction of a Flow Control Valve Assembly into the Standard Y-Connector Assembly. A system such as this adds value to the current design by increasing worker productivity while maintaining the quality of work.

### BRIEF DESCRIPTION OF DRAWINGS

FIG. 1: Block diagram of a simple carpet cleaning system with one wand.

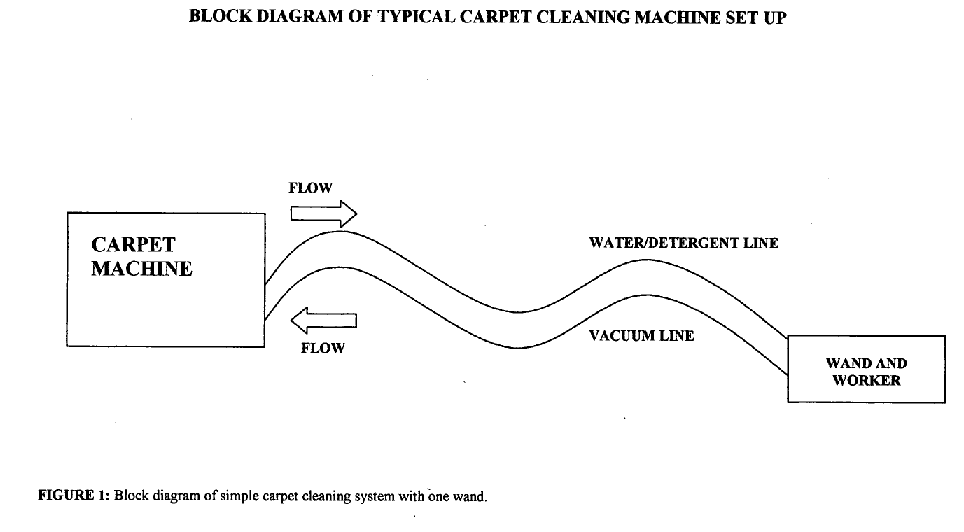

FIG. 2: Block diagram of a simple carpet cleaning system with currently available Y connector and two wands.

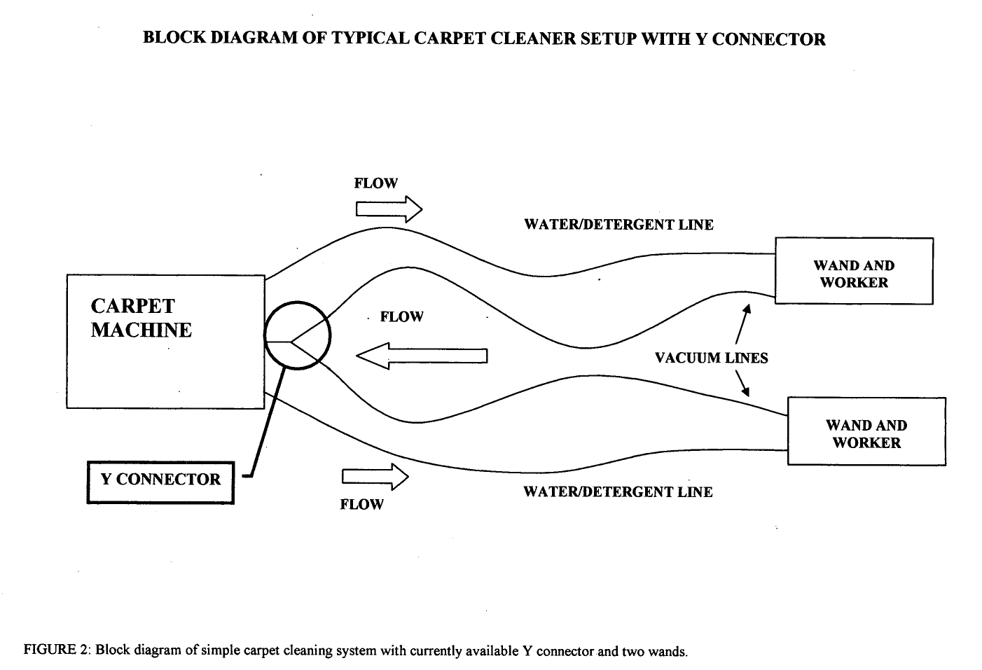

FIG. 3: Drawing of Y connector under ideal conditions i.e. when both wands are in use and on the carpet.

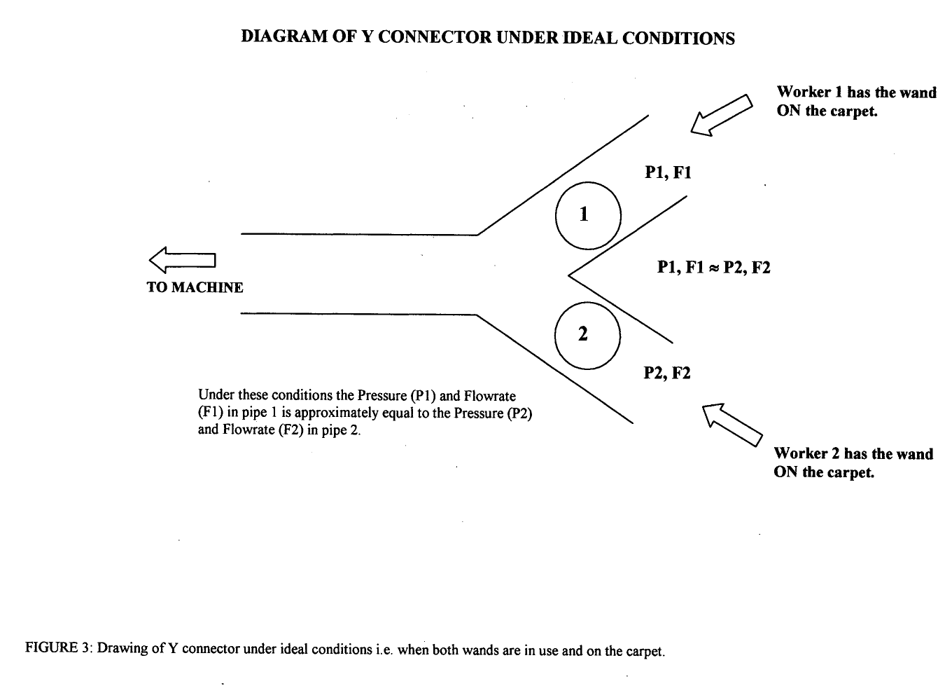

FIG. 4: Drawing of Y connector under non-ideal conditions i.e. when both wands are in use and on the carpet.

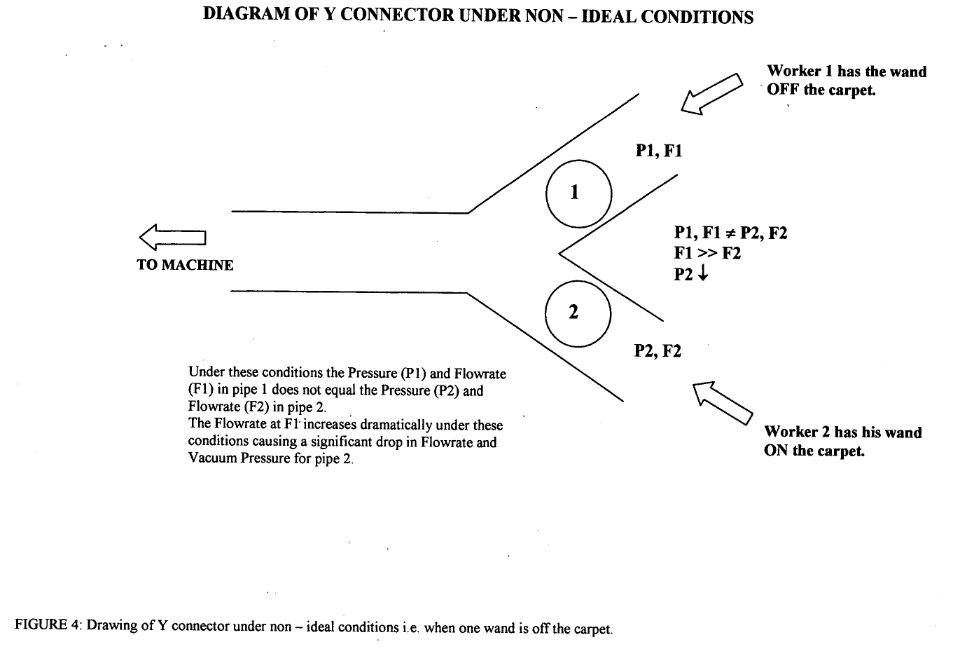

FIG. 5: Drawing of Flow Controlled Y Connector operating under non-ideal conditions i.e. when one wand is off the carpet.

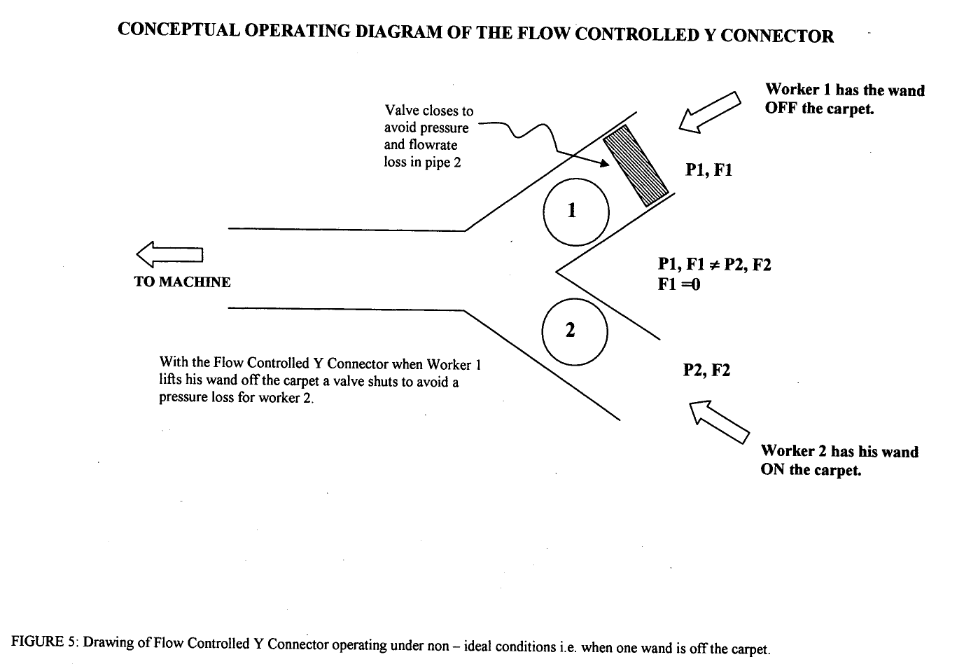

FIG. 6: Drawing of a typical Y connector currently available.

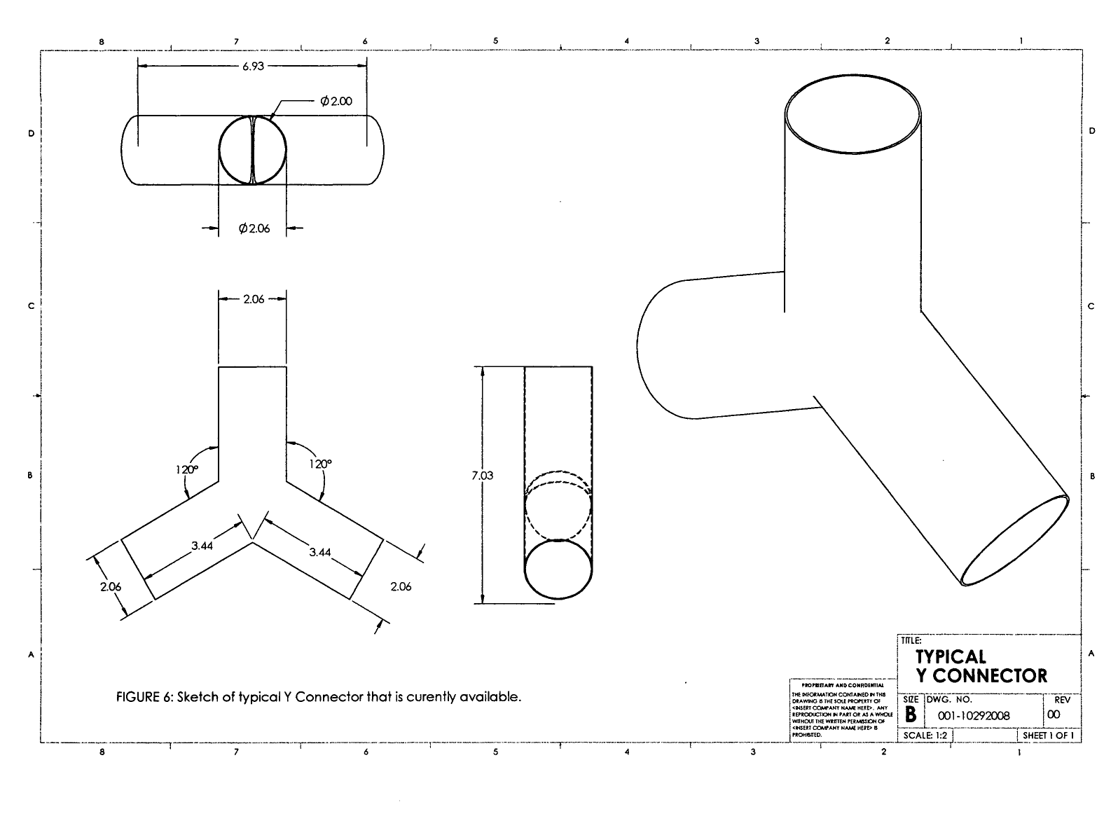

FIG. 7: Sketch of Flow Controlled Y Connector.

FIG. 8: Sketch of Y Connector used in Flow Controlled Y Connector.

FIG. 9: Sketch of Flow Control Valve Assembly.

FIG. 10: Sketch of Pipe Insert.

FIG. 11: Sketch of Flap.

FIG. 12: Sketch of Flap Holder.

FIG. 13: Sketch of Rod.

FIG. 14: Bolt detail.

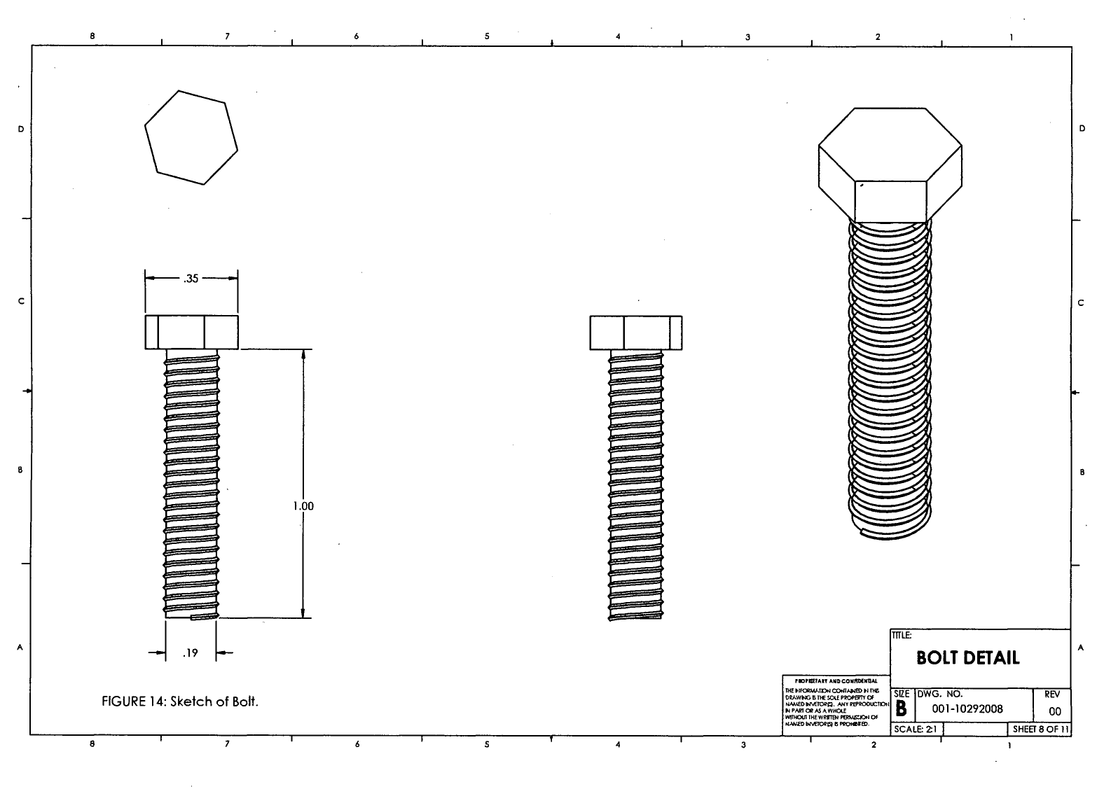

FIG. 15: Sketch of Washer.

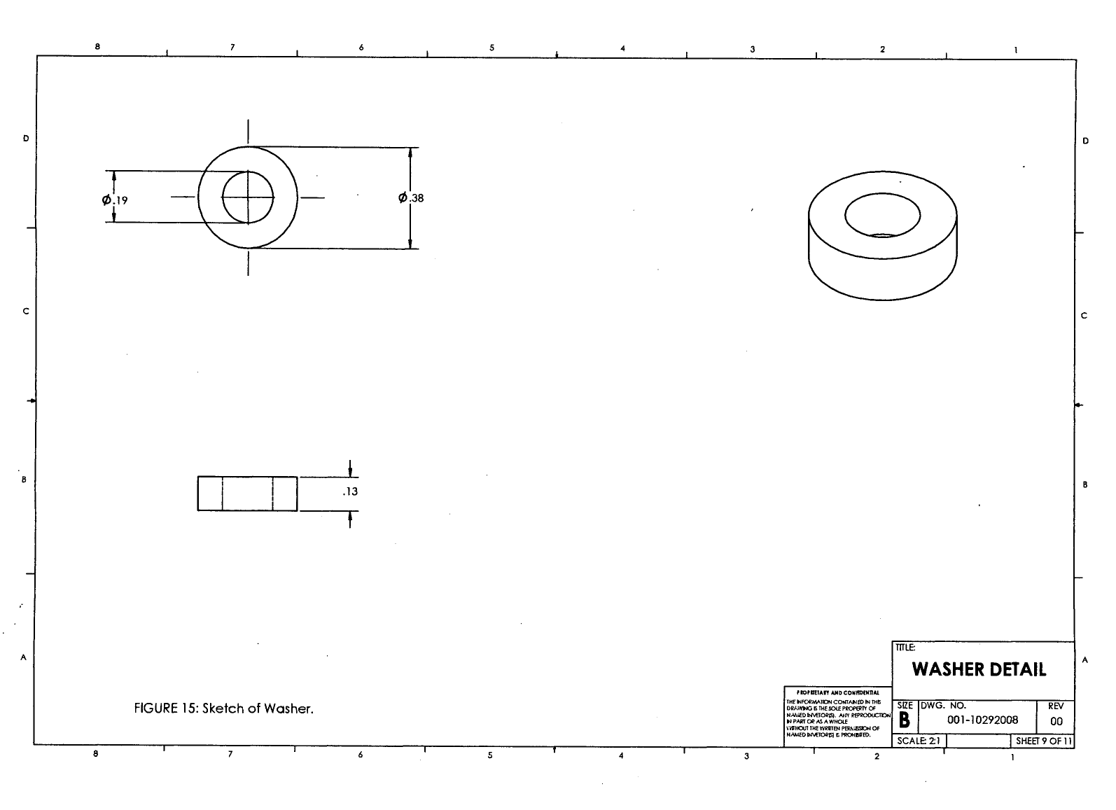

FIG. 16: Sketch of End Section.

FIG. 17: Sketch of Flow Control Valve Pipe.

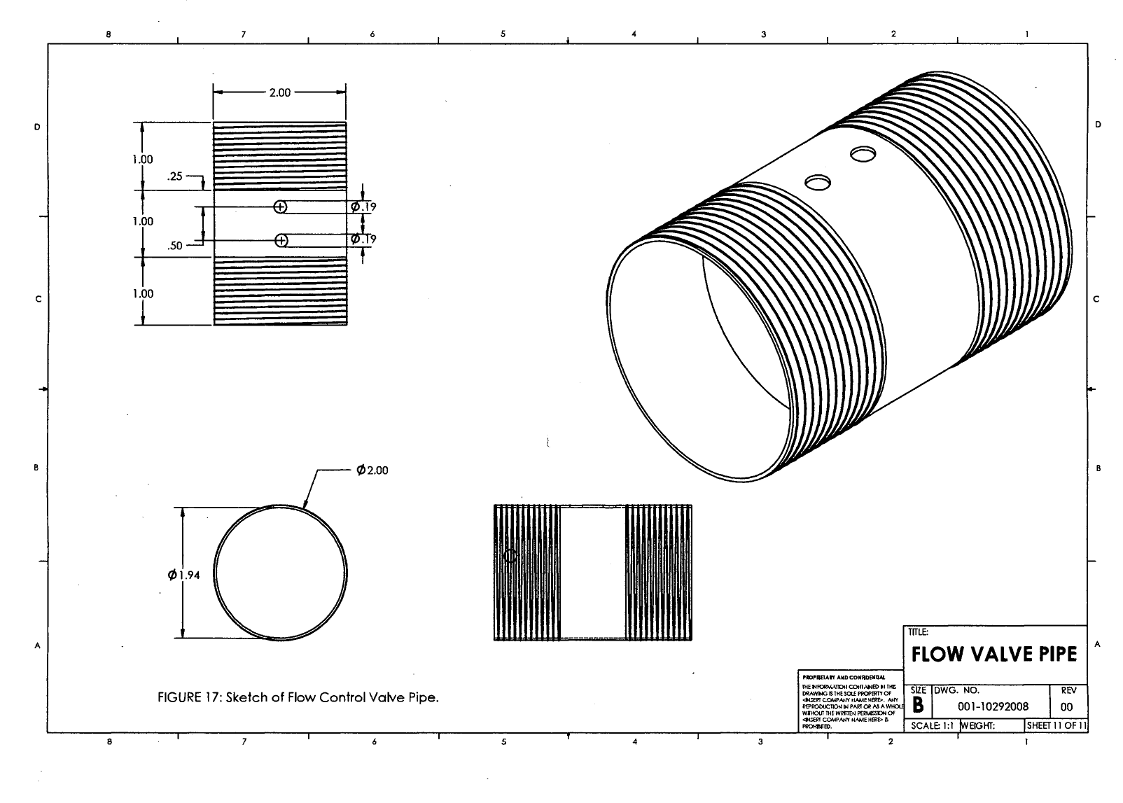

### DETAILED DESCRIPTION OF THE INVENTION

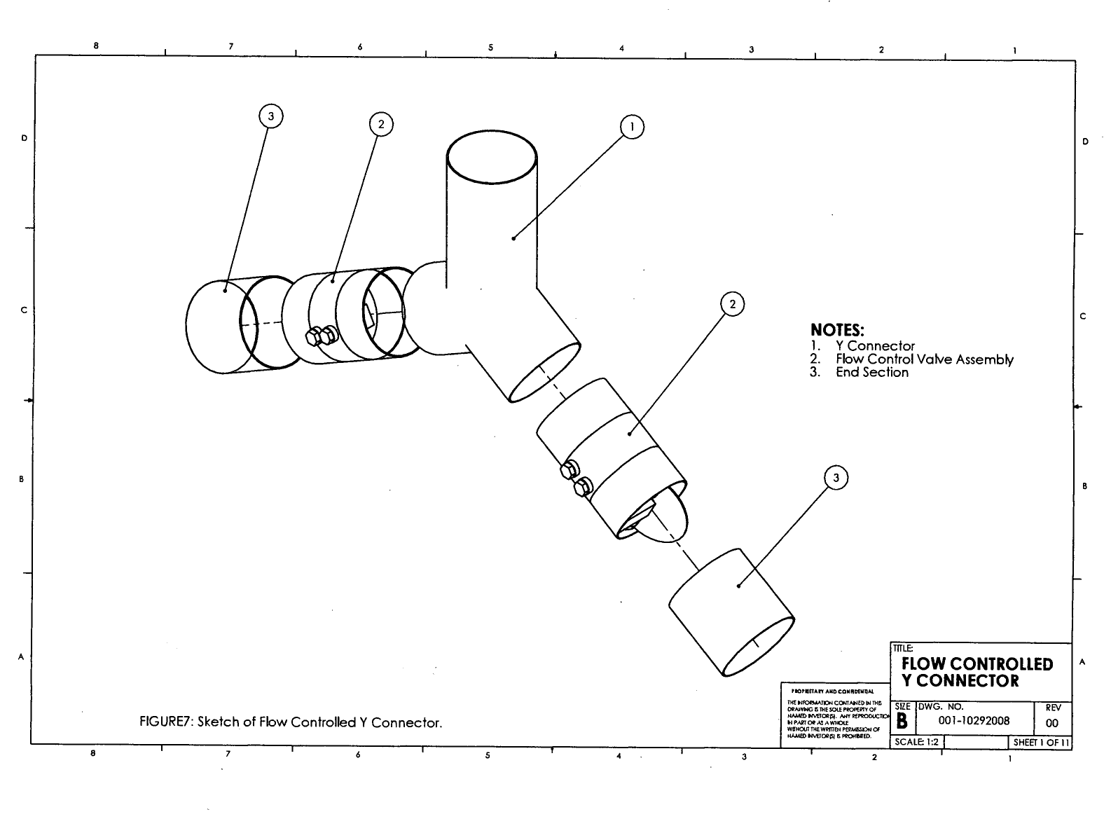

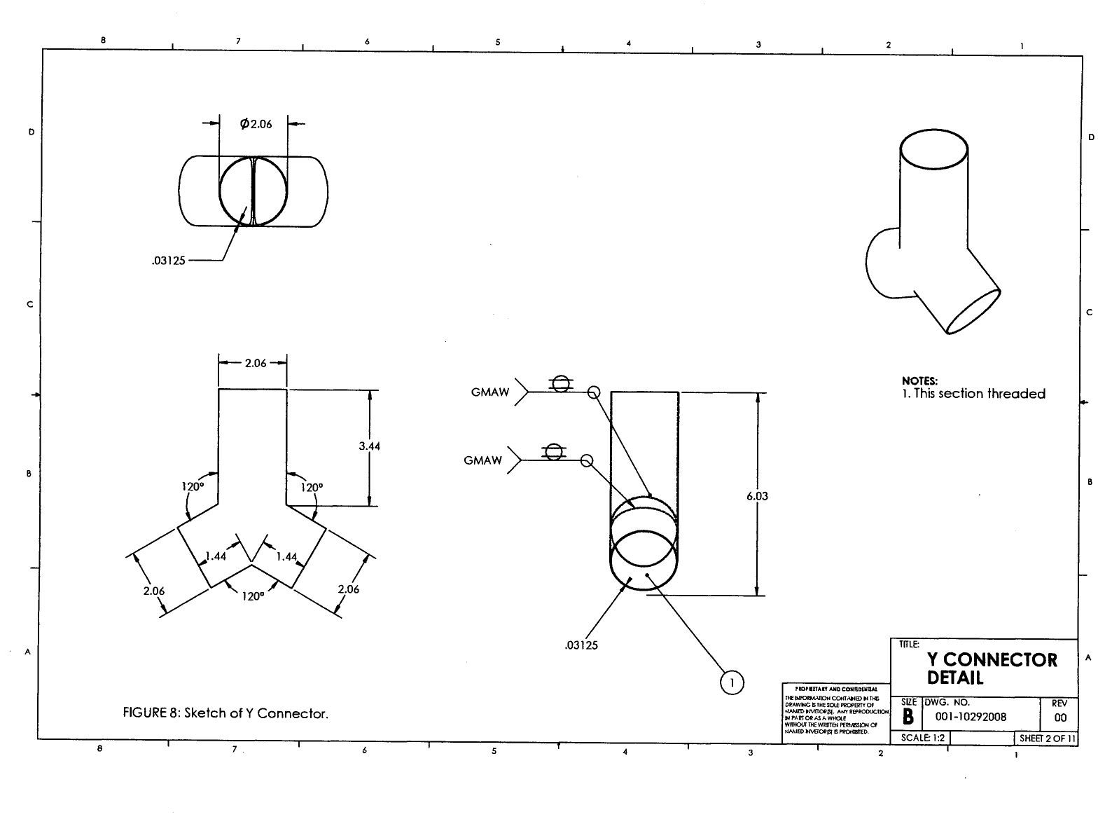

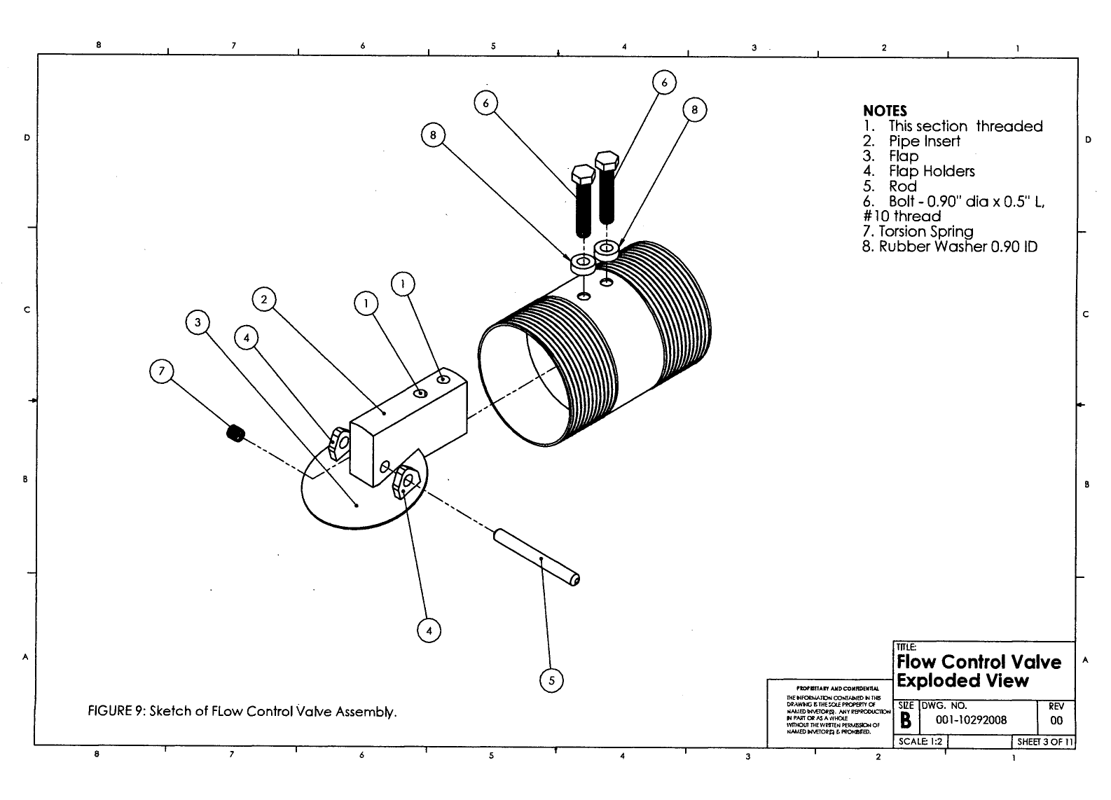

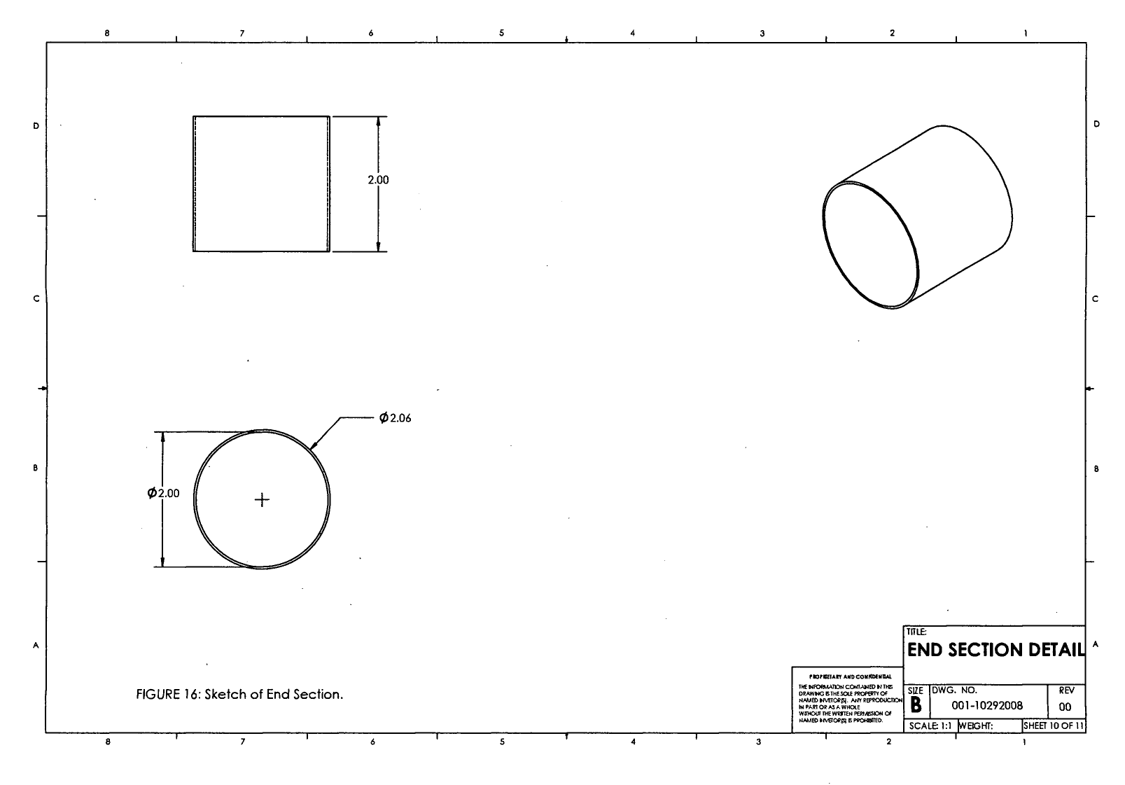

The Flow Controlled Y Connector is a device that controls the flow of air, water, and debris flowing into a vacuum. The device consists of three main components (FIG. 7):
Y Connector (FIG. 8)
Flow Control Valve (FIG. 9)
End Section (FIG. 16)

The Y Connector and End Sections are internally threaded to accommodate the Flow Valve Control Assemblies which are externally threaded.

The Flow Control Valve Assembly is the part of the body that controls the flow of air, water, and debris.

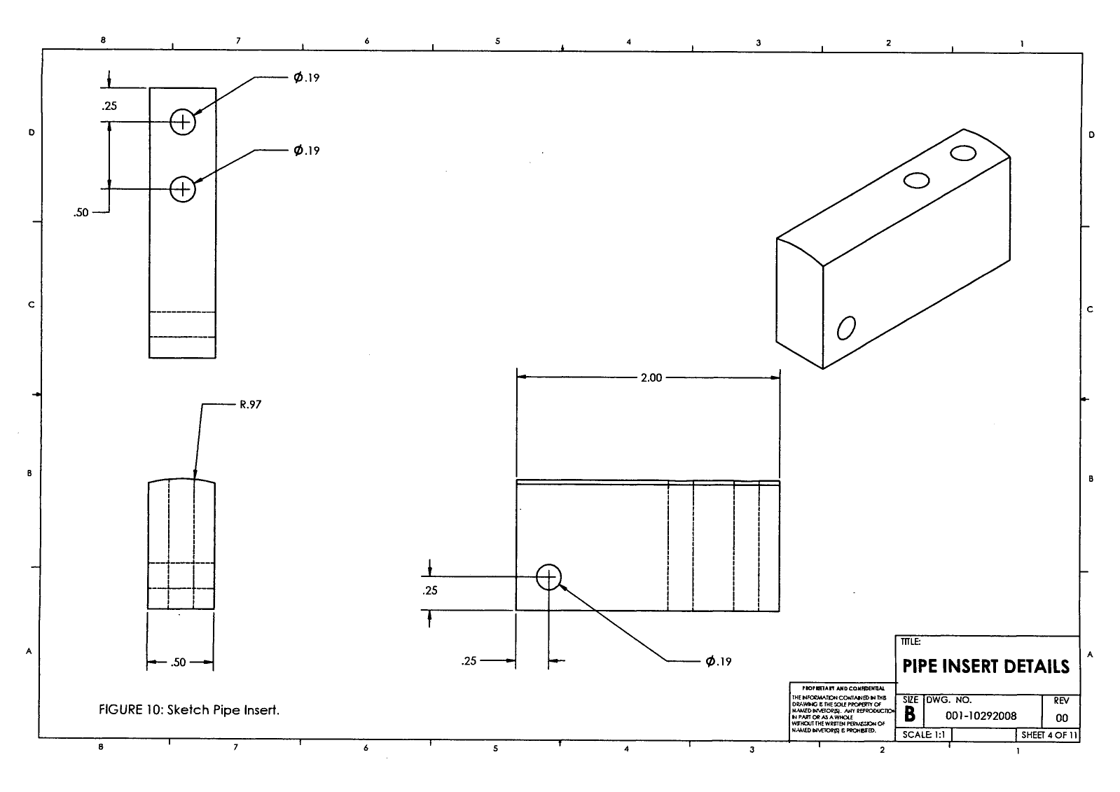

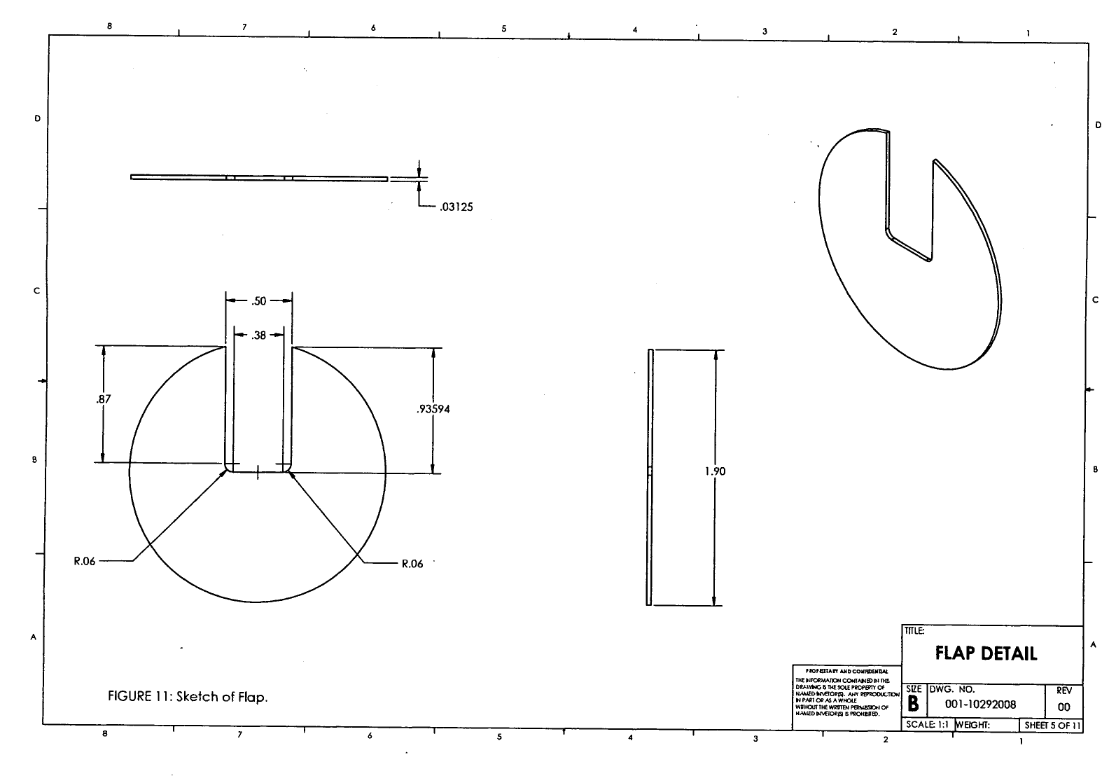

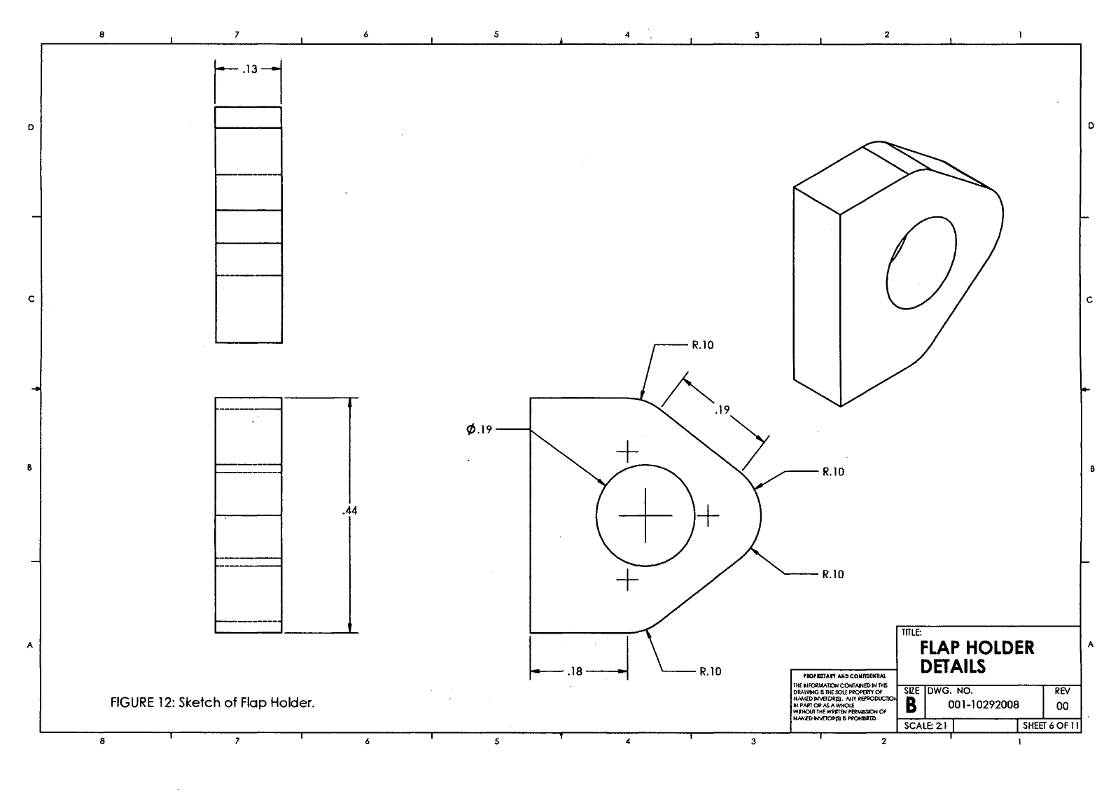

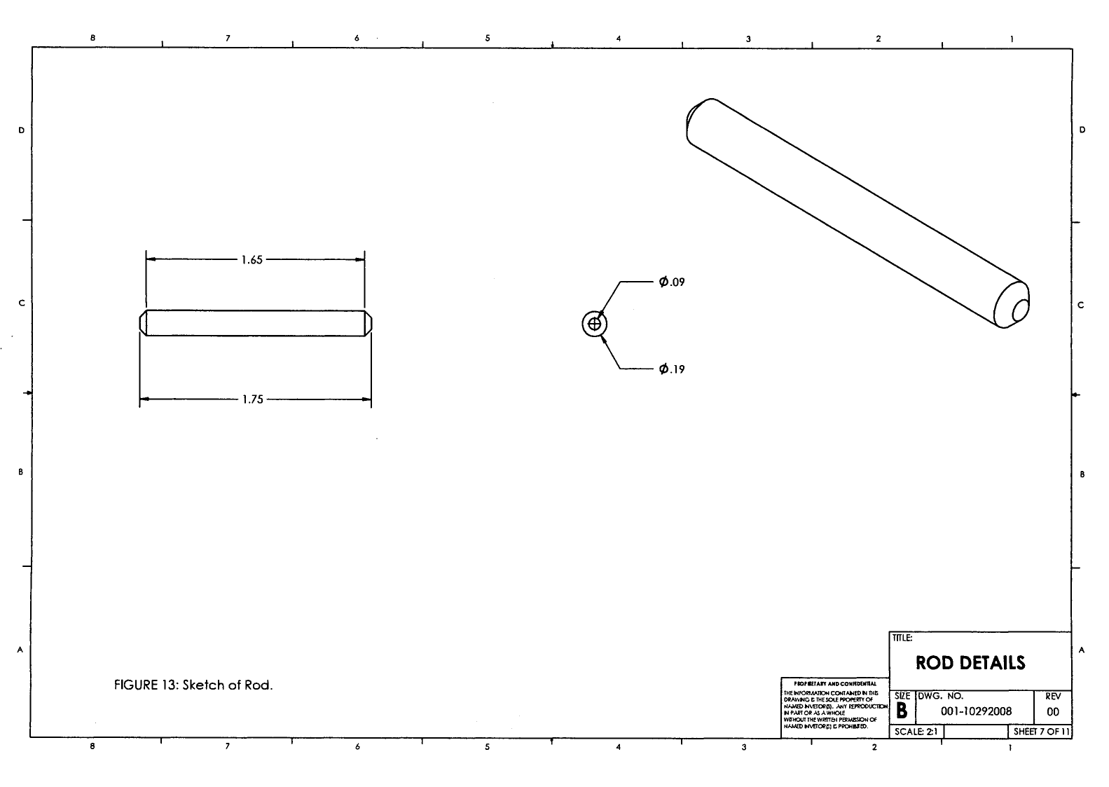

The Flow Control Valve Assembly consists of the following parts (FIG. 9):
Pipe Insert (FIG. 10)
Flap (FIG. 11)
Flap Holders (FIG. 12)
Rod (FIG. 13)
Torsion Spring
Flow Valve Pipe

The Pipe Insert has two threaded holes located on the top of the part which mounts inside of the pipe using two #10 thread bolts that are 1 inch long. The Pipe Insert is used to mount a rod which is used to mount the Flap. The Flap is the component that controls the flowrate inside of the Y-Connector. The Flap responds to an increased flowrate by closing due to the drag increase on the top of the Flap. The Flap returns to an open position once the flow rate has decreased. The Flap opens due to the force created by the torsion spring. This process repeats until the carpet cleaning machine is turned off.

What is claimed is:

1. A process by which to control the flow of matter through the Y connector.

2. The flow valve assembly used to control the flow rate throughout the piping system.

3. The unique configuration of parts and the unique parts used to construct the Flow Control Valve Assembly.

4. The use of the Flow Controlled Y Connector with various carpet cleaning equipment set forth in claim 1.

5. Any dimensional variation in the general design configuration set forth in claim 3.
